(19) United States
(12) Patent Application Publication
(10) Pub. No.: US 2019/0205855 A1
(43) Pub. Date: Jul. 4, 2019

(54) POINT-OF-SALE SYSTEM FOR PROCESSING A PAYMENT TRANSACTION ACROSS MULTIPLE POINT-OF-SALE DEVICES

(71) Applicant: Mastercard International Incorporated, Purchase, NY (US)

(72) Inventors: Kathy Ann Simon, St. Peters, MO (US); Courtney Brown, Saint Charles, MO (US)

(73) Assignee: Mastercard International Incorporated, Purchase, NY (US)

(21) Appl. No.: 15/860,453

(22) Filed: Jan. 2, 2018

(51) Int. Cl. G06Q 20/20; G06Q 20/40; G06Q 20/36

(52) U.S. Cl. CPC G06Q 20/20; G06Q 20/36; G06Q 20/401

(57) ABSTRACT

A point-of-sale system for processing a payment transaction includes a first point-of-sale device having a memory device and a first processor coupled to the memory device. The first processor is programmed to receive transaction card information including a primary account number relating to a payment account of a cardholder. The first processor is also programmed to transmit a payment authorization request message. Furthermore, the first processor is programmed to present to the cardholder a transaction identifier for the payment transaction, and store transaction data associated with the payment transaction in the memory device. The system also includes a second point-of-sale device having a second processor programmed to receive the transaction identifier for the payment transaction, retrieve the transaction data associated with the transaction identifier from the memory, and transmit an authorization advice message.

### FIELD OF THE DISCLOSURE

The field of the disclosure relates generally to systems and methods for processing payment transactions and, more particularly, to systems and methods for processing a payment transaction across multiple point-of-sale devices at a merchant store.

### BACKGROUND OF THE DISCLOSURE

When using a transaction card, such as a debit card or a credit card, to purchase fuel and pay at the pump, the transaction card is typically presented at the beginning of the transaction. However, at the beginning of the transaction, the amount of fuel, and thus the total purchase price, has not been determined. Because a cardholder could present a valid transaction card, but one which has insufficient funds available to purchase the amount of fuel ultimately pumped into the vehicle, a hold may be placed against the cardholder's payment account to ensure sufficient funds to complete the transaction. In some instances, the hold may be much greater than the amount of fuel ultimately purchased, which may prevent the cardholder from making additional purchases inside the merchant store using the same transaction card.

In addition, at least some cardholders believe that they cannot make multiple purchases at a single merchant location within a short time period. Thus, the cardholder may choose to pay inside rather than at the pump, where the cardholder can choose additional items for purchase, or the cardholder may forego going inside altogether and only pay at the pump. Instances where the cardholder chooses to pay at the pump and forego purchases at the counter because of the mistaken belief that multiple purchases at a single merchant location within a short time period are impermissible may result in lost sales to the merchant. In addition, such beliefs may result in unnecessary inconvenience to the cardholder.

### BRIEF DESCRIPTION OF THE DISCLOSURE

This summary is not intended to identify essential features of the present disclosure, and is not intended to be used to limit the scope of the claims. These and other aspects of the present disclosure are described below in greater detail.

In one aspect, a point-of-sale system for processing a payment transaction at a merchant store is provided. The point-of-sale system includes a first point-of-sale device having a memory device for storing data; and a first processor communicatively coupled to the memory device. The first processor is programmed to receive transaction card information for the payment transaction. The transaction card information includes a primary account number relating to a payment account of a cardholder. The first processor is also programmed to transmit a payment authorization request message including the primary account number. Moreover, the first processor is programmed to present to the cardholder a transaction identifier for the payment transaction, and store transaction data associated with the payment transaction in the memory device. The system also includes a second point-of-sale device having a second processor programmed to receive the transaction identifier for the payment transaction. The second processor is also programmed to retrieve the transaction data from the memory device associated with the transaction identifier, and transmit an authorization advice message including the primary account number relating to the payment account.

### BRIEF DESCRIPTION OF THE DRAWINGS

Embodiments of the present disclosure are described in detail below with reference to the attached drawing figures, wherein:

FIG. 1 is a block diagram of an example multi-party payment card network system including a plurality of point-of sale (POS) devices in accordance with one embodiment of the present disclosure;

FIG. 2 is a simplified block diagram of an example transaction processing system (TPS) for processing merchant transactions via the payment card network system shown in FIG. 1;

FIG. 3 is an example configuration of a server system, such as a server system for use in the system shown in FIG. 2;

FIG. 4 is an example configuration of a POS device, such as a POS device of the payment card network system shown in FIG. 1;

FIGS. 5A and 5B illustrated a flow chart of an example method for processing a payment transaction at a merchant store.

The figures are not intended to limit the present disclosure to the specific embodiments they depict. The drawings are not necessarily to scale. Like numbers in the Figures indicate the same or functionally similar components.

### DETAILED DESCRIPTION OF THE DISCLOSURE

The following detailed description of embodiments of the disclosure references the accompanying figures. The embodiments are intended to describe aspects of the disclosure in sufficient detail to enable those with ordinary skill in the art to practice the disclosure. The embodiments of the disclosure are illustrated by way of example and not by way of limitation. Other embodiments may be utilized and changes may be made without departing from the scope of the claims. The following description is, therefore, not limiting. It is contemplated that the disclosure has general application to processing a single transaction across multiple point-of-sale devices. The scope of the present disclosure is defined only by the appended claims, along with the full scope of equivalents to which such claims are entitled.

In this description, references to “one embodiment,” “an embodiment,” or “embodiments” mean that the feature or features referred to are included in at least one embodiment of the disclosure. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, implementations of the present disclosure can include a variety of combinations and/or integrations of the embodiments described herein.

Broadly characterized, the present disclosure relates to a point-of-sale system for processing a payment transaction across multiple point-of-sale (POS) devices. More particularly, the disclosed embodiments provide a system and computer-implemented method for initiating a transaction at a first POS device, wherein the first POS device transmits a preauthorization message to an issuer, and completing the transaction at a second POS device, wherein the second POS device transmits an authorization advice message to the issuer including the final transaction amount. In one example embodiment, the system includes a first POS device configured to receive transaction card information for the payment transaction. The transaction card information includes a primary account number (PAN) relating to a payment account of a cardholder. The first POS device transmits a payment authorization request message including the PAN to the issuer. The cardholder may be presented with a transaction identifier for the payment transaction. At a second POS device, the cardholder may provide the transaction identifier, so the second POS device may retrieve the transaction from the first POS device. The cardholder may add additional items to the transaction and complete the transaction at the second POS device.

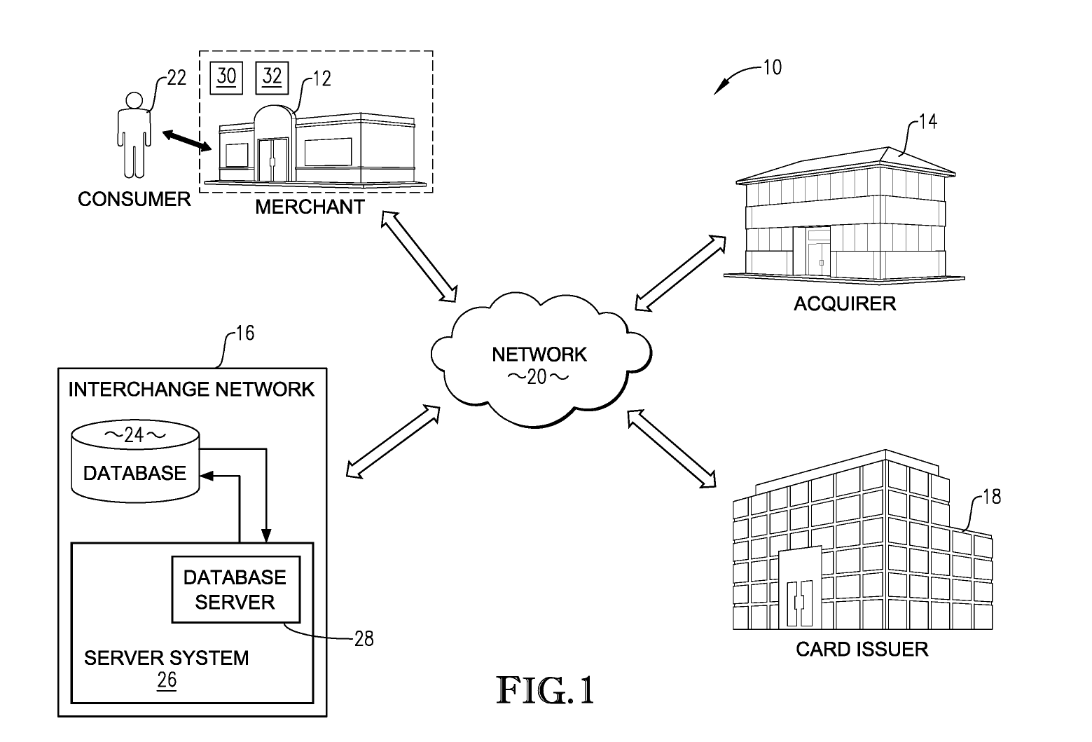

FIG. 1 is a block diagram of an example multi-party payment card network system 10 including a plurality of point-of sale (POS) devices, including at least a first POS device 30 and a second POS device 32, in accordance with one embodiment of the present disclosure. The payment card network system 10 facilitates payment card transactions in which merchants 12, acquirers 14, and/or card issuers 18 do not need to have a one-to-one relationship. The payment card network system 10 may be utilized by the merchants 12 as part of a process of initiating an authorization request and performing a transaction (as described herein) via an interchange network 16. In the example embodiment, the payment card network system 10 generally includes the merchants 12, the acquirers 14, the interchange network 16, and the issuers 18, coupled in communication via a network 20.

The network 20 includes, for example and without limitation, one or more of a local area network (LAN), a wide area network (WAN) (e.g., the Internet, etc.), a mobile network, a virtual network, and/or any other suitable public and/or private network capable of facilitating communication among the merchants 12, the acquirers 14, the interchange network 16, and/or the issuers 18. In some embodiments, the network 20 may include more than one type of network, such as a private payment transaction network provided by the interchange network 16 to the acquirers 14 and the issuers 18 and, separately, the public Internet, which may facilitate communication between the merchants 12, the interchange network 16, the acquirers 14, and the consumers or cardholders 22, etc.

Embodiments described herein may relate to a transaction card system, such as a credit card payment system using the Mastercard® interchange network. (Mastercard is a registered trademark of Mastercard International Incorporated.) The Mastercard interchange network is a set of proprietary communications standards promulgated by Mastercard International Incorporated for the exchange of financial transaction data and the settlement of funds between financial institutions that are members of Mastercard International Incorporated. As used herein, financial transaction data includes a unique account number associated with an account holder using a payment card issued by an issuer, purchase data representing a purchase made by the cardholder, including a type of merchant, amount of purchase, date of purchase, and other data, which may be transmitted between any parties of multi-party payment card network system 10.

In a typical transaction card system, a financial institution called the “issuer” issues a transaction card, such as a credit card, to a cardholder 22, who uses the transaction card to tender payment for a purchase from the merchant 12. In the example embodiment, the merchant 12 is typically associated with products, for example, and without limitation, goods and/or services, that are offered for sale and are sold to the consumers 22. The merchant 12 includes, for example, a physical location that includes, for example, a brick-and-mortar store, etc.

To accept payment with the transaction card, the merchant 12 must normally establish an account with a financial institution that is part of the payment card network system 10. This financial institution is usually called the “merchant bank,” the “acquiring bank,” or the acquirer 14. When the cardholder 22 initiates payment for a purchase with a transaction card, the merchant 12 requests authorization from the acquirer 14 for the amount of the purchase or, in some embodiments, for an estimated amount of the purchase. The request may be performed over the telephone, but is usually performed by one or more of the POS devices 30 and 32 that read the cardholder's account information from a magnetic stripe, an integrated circuit or chip, or embossed characters on the transaction card and communicates electronically with the transaction processing computers of the acquirer 14. Alternatively, the acquirer 14 may authorize a third party to perform transaction processing on its behalf. In this case, the POS devices 30 and 32 will be configured to communicate with the third party. Such a third party is usually called a “merchant processor,” an “acquiring processor,” or a “third party processor.”

Using the interchange network 16, computers of the acquirer 14 or merchant processor will communicate with computers of the issuer 18 to determine whether the cardholder's account is in good standing and whether the purchase amount or estimated amount is covered by the cardholder's available credit line (e.g., for credit card accounts) or available funds (e.g., for direct deposit accounts (DDA)). Based on these determinations, the request for authorization will be declined or authorized. If the request is authorized, an authorization code is issued to the merchant 12. For estimated amounts, a hold is often placed against the cardholder's account to ensure sufficient funds to complete the purchase.

When a request for authorization is authorized, the available credit line of the cardholder's account is decreased, or a hold is placed against the account for an estimated amount. Normally, a charge for a payment card transaction is not posted immediately to the cardholder's account because bankcard associations, such as Mastercard International Incorporated, have promulgated rules that do not allow the merchant 12 to charge, or “capture,” a transaction until the purchased goods are shipped or the purchased services are delivered. However, with respect to at least some debit card transactions, a charge may be posted at the time or close of the transaction. When the merchant 12 ships or delivers the goods or services, the merchant 12 captures the transaction by, for example, appropriate data entry procedures on the POS devices 30 and 32. This may include bundling of approved transactions daily for standard retail purchases. If the cardholder 22 cancels a transaction before it is captured, a “void” is generated. If the cardholder 22 returns goods after the transaction has been captured, a “credit” is generated. The interchange network 16 and/or the issuer 18 stores the transaction card information, such as, and without limitation, a type of merchant, a merchant identifier, a location where the transaction was completed, an amount of purchase, and a date and time of the transaction, in a transaction database 24.

After a purchase has been made, a clearing process occurs to transfer additional transaction data related to the purchase among the parties to the transaction, such as the acquirer 14, the interchange network 16, and the issuer 18. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction.

For debit card transactions (e.g., DDA transactions), when a request for a personal identification number (PIN) authorization is approved by the issuer 18, the cardholder's account is decreased. Normally, a charge is posted immediately to the cardholder's account. The interchange network 16 transmits the approval to the acquirer 14 for distribution of goods/services or information, or cash in the case of an automated teller machine (ATM).

After a transaction is authorized and cleared, the transaction is settled among the merchant 12, the acquirer 14, and the issuer 18. Settlement refers to the transfer of financial data or funds among the merchant 12, the acquirer 14, and the issuer 18 related to the transaction. Usually, transactions are captured and accumulated into a “batch,” which is settled as a group. More specifically, a transaction is typically settled between the issuer 18 and the interchange network 16, and then between the interchange network 16 and the acquirer 14, and then between the acquirer 14 and the merchant 12.

With continued reference to FIG. 1, the interchange network 16 includes a server system 26, which is, for example, and without limitation, a server, a network of multiple computing devices, a virtual computing device, or the like. The server system 26 includes a database server 28 that is connected to the transaction database 24. In one embodiment, the transaction database 24 is stored on the server system 26; however, in other embodiments, the transaction database 24 is stored remotely from the server system 26 and may be non-centralized.

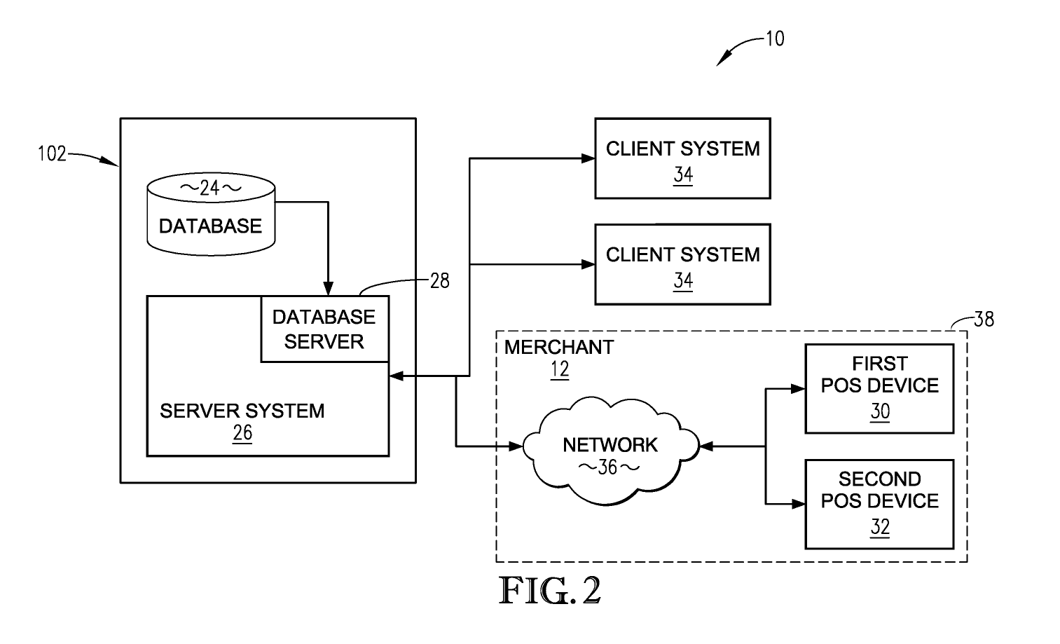

FIG. 2 is a simplified block diagram of an example transaction processing system (TPS) 102 for processing merchant transactions via the payment card network system 10. In the example embodiment, the payment network 10 includes a plurality of computing devices connected in accordance with the present disclosure. The payment card network system 10 includes the server system 26 of the TPS 102 in communication with a point-of-sale system 38, which preferably includes the POS devices 30 and 32 at a merchant location, and/or one or more client systems 34 associated with merchants, merchant banks, payment networks, and/or issuer banks. According to some aspects of the disclosure, the point-of-sale system 38 may include additional POS devices beyond those illustrated.

More specifically, in the example embodiment, the TPS 102 includes the server system 26 of, for example, the interchange network 16 (shown in FIG. 1), in communication with the point-of-sale system 38 (e.g., the POS devices 30 and 32) and the client systems 34 associated with merchants, merchant banks, payment networks, and/or issuer banks. The server system 26 is also in communication with a plurality of client sub-systems, also referred to as the client systems 34. In one embodiment, the client systems 34 are computers including a web browser, such that server system 26 is accessible to the client systems 34 using the Internet. The client systems 34 are interconnected to the Internet through one or more of many interfaces including, for example, a network, such as a LAN or WAN, dial-in-connections, cable modems, and/or special high-speed Integrated Services Digital Network (ISDN) lines. The client systems 34 could be any device capable of interconnecting to the Internet including an Internet connected phone, a PDA, or any other suitable web-based connectable equipment.

In the example embodiment, the TPS 102 also includes the point-of-sale system 38 including the POS devices 30 and 32, which may be connected to the client systems 34 and may be connected to the server system 26. The point-of-sale system 38 is interconnected to the Internet (or any other network that allows the POS devices 30 and 32 to communicate as described herein) through many interfaces including a network 36, such as a local area network (LAN) or a wide area network (WAN), dial-in-connections, cable modems, wireless modems, and special high-speed ISDN lines. The POS devices 30 and 32 of the point-of-sale system 38 are any devices capable of interconnecting to the network 36 (and the Internet) and including an input device capable of reading information from a cardholder's financial transaction card. As used herein, the terms POS device and POS terminal are used broadly, generally, and interchangeably to refer to any device in which a cardholder interacts with a merchant to complete a payment card transaction.

As described above, the database server 28 is connected to the database 24, which is configured to store information on a variety of matters. In one embodiment, the database 24 is a centralized database stored on the server system 26 and can be accessed by potential users at one of the client systems 34 by logging onto the server system 26 through one of the client systems 34. In an alternative embodiment, the database 24 is stored remotely from the server system 26 and may be a distributed or non-centralized database.

In one example embodiment, the database 24 may include a single database having separated sections or partitions or may include multiple databases, each being separate from each other. The database 24 may store transaction data generated as part of sales activities and savings activities conducted over the processing network 10 including data relating to merchants, account holders or customers, issuers, acquirers, savings amounts, savings account information, and/or purchases made. The database 24 may also store account data including at least one of a cardholder name, a cardholder address, an account number, and other account identifier. The database 24 may also store merchant data including a merchant identifier that identifies each merchant 12 registered to use the network 10, and instructions for settling transactions including merchant bank account information. The database 24 may also store purchase data associated with items being purchased by the cardholder 22 from the merchant 12, and authorization request data.

In the example embodiment, one of the client systems 34 may be associated with the acquirer 14 (shown in FIG. 1) while another one of the client systems 34 may be associated with the issuer 18 (shown in FIG. 1). The point-of-sale system 38 may be associated with the merchant 12. The server system 26 may be associated with the interchange network 16 or a payment processor (not shown). In the example embodiment, the server system 26 is associated with a financial transaction processing network, such as the interchange network 16, and may be referred to as an interchange computer system. The server system 26 may be used for processing transaction data. In addition, the client systems 34 and the point-of-sale system 38 may include a computer system associated with at least one of the merchant 12, an online bank, a bill payment outsourcer, an acquirer bank, an acquirer processor, an issuer bank associated with a transaction card, an issuer processor, a remote payment processing system, and/or a biller. It is noted that the payment card network system 10 may include more, fewer, or alternative components and/or perform more, fewer, or alternative actions, including those discussed elsewhere herein.

The embodiments illustrated and described herein as well as embodiments not specifically described herein but within the scope of aspects of the disclosure constitute exemplary means for performing financial transactions, and more particularly, constitute exemplary means for performing a financial transaction using a plurality of interconnected POS devices 30 and 32 (i.e., the point-of-sale system 38). For example, the server system 26, the POS devices 30 and 32, or any other similar computer devices, programmed with computer-executable instructions to execute processes and techniques with a processor as described herein, constitutes exemplary means for enabling merchants to conduct, manage, and track electronic transactions across a plurality of POS devices 30 and 32 relating to purchases of a merchant's goods and services.

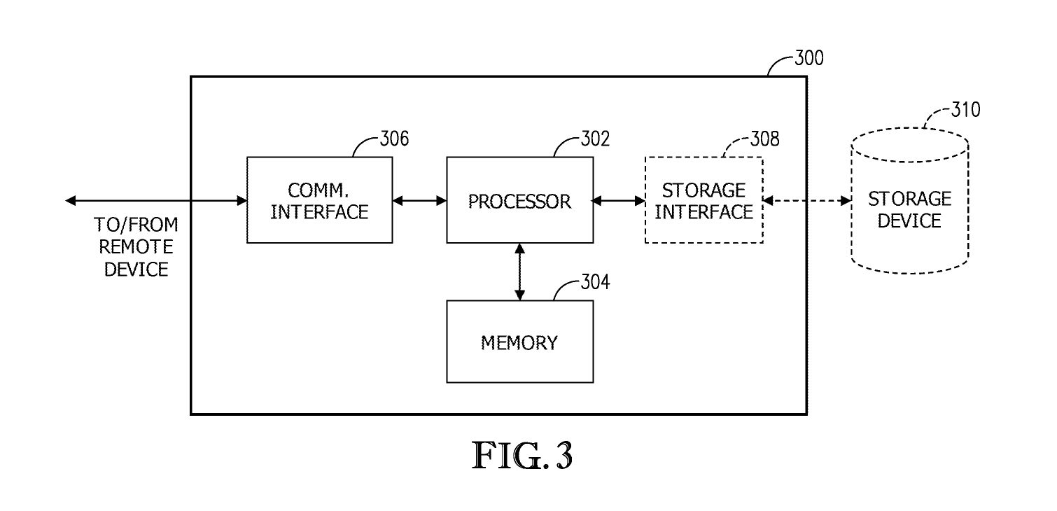

FIG. 3 is an example configuration of a server system 300, such as the server system 26 (shown in FIG. 2). The server system 300 includes, but is not limited to, the transaction database 24 (shown in FIG. 1). In the example embodiment, the server system 300 includes a processor 302 for executing instructions. The instructions may be stored in a memory area 304, for example. The processor 302 includes one or more processing units (e.g., in a multi-core configuration) for executing the instructions. The instructions may be executed within a variety of different operating systems on the server system 300, such as UNIX, LINUX, Microsoft Windows®, etc. More specifically, the instructions may cause various data manipulations on data stored in a storage device 310 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 302 is operatively coupled to a communication interface 306 such that the server system 300 can communicate with remote devices such as POS devices 30 and 32 (shown in FIG. 2) or another server system (not shown). For example, the communication interface 306 may receive communications from a client system 34 via the Internet, as illustrated in FIG. 2.

The processor 302 is operatively coupled to the storage device 310. The storage device 310 is any computer-operated hardware suitable for storing and/or retrieving data. In some embodiments, the storage device 310 is integrated in the server system 300. In other embodiments, the storage device 310 is external to the server system 300 and is similar to the transaction database 24. For example, the server system 300 may include one or more hard disk drives as the storage device 310. In other embodiments, the storage device 310 is external to the server system 300 and may be accessed by a plurality of server systems 300. For example, the storage device 310 may include multiple storage units such as hard disks or solid-state disks in a redundant array of inexpensive disks (RAID) configuration. The storage device 310 may include a storage area network (SAN) and/or a network attached storage (NAS) system.

In some embodiments, the processor 302 is operatively coupled to the storage device 310 via a storage interface 308. The storage interface 308 is any component capable of providing the processor 302 with access to the storage device 310. The storage interface 308 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 302 with access to the storage device 310.

The memory area 304 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

In the example embodiment, the server system 300 is a transaction processing system in communication with one or more of the issuer 18 and the merchant 12 during a payment card transaction of a user, such as the cardholder 22 (shown in FIG. 1). The server system 300 performs checking for account information updates for accounts initiating a payment transaction and provides updated account information indicators to a merchant associated with the payment transaction.

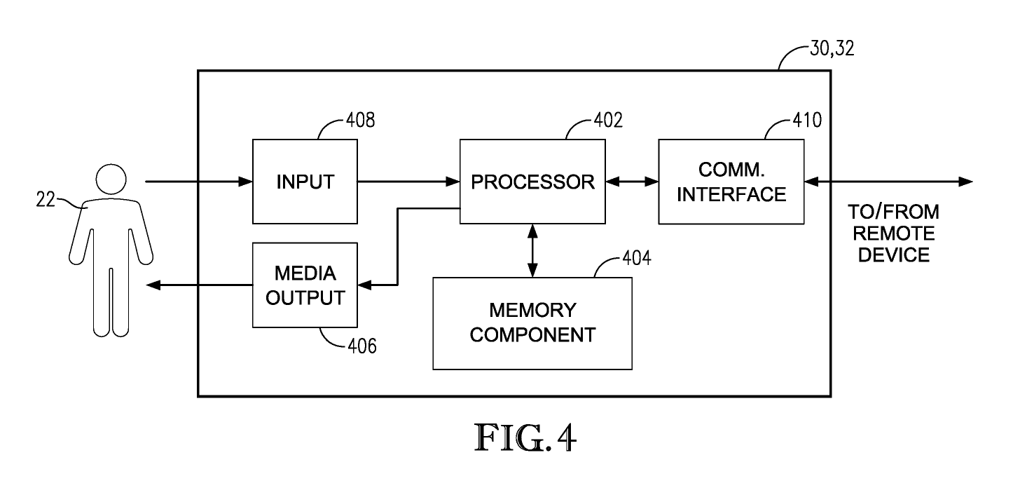

FIG. 4 illustrates an example configuration of a POS device, such as one of the POS devices 30 and 32 of the point-of-sale system 38, operated by a user, such as the cardholder 22. Many different types of merchants 12 (shown in FIG. 2), each represented by the POS devices 30 and 32, may be connected to the payment card network system 10 (shown in FIG. 2). Each merchant 12 may include at least two POS devices, including the first POS device 30 and the second POS device 32. In the example embodiment, at least one of the POS devices 30 and 32 is integrated into or located proximate to an automated fuel pump, and the merchant 12 is an automotive fuel filling station.

With reference to FIG. 2, the POS devices 30 and 32 include a processor 402 for executing instructions. In some embodiments, executable instructions are stored in a memory component 404. The processor 402 may include one or more processing units, for example, a multi-core configuration. The memory component 404 is any device allowing information such as executable instructions and/or other data to be stored and retrieved. The memory component 404 may include one or more computer readable media.

The POS devices 30 and 32 also preferably include at least one media output component 406 for presenting information to the cardholder 22. The media output component 406 is any component capable of conveying information to the cardholder 22. In some embodiments, the media output component 406 includes an output adapter such as a video adapter and/or an audio adapter. An output adapter is operatively coupled to the processor 402 and operatively couplable to an output device such as a display device, a monitor, a liquid crystal display (LCD), organic light emitting diode (OLED) display, or “electronic ink” display, and/or an audio output device, a speaker, or headphones. In some embodiments, the media output component 406 may optionally include a touch controller for support of touch capability. Incorporating a touch controller into the media output component 406 may facilitate preventing access by malicious software, thereby ensuring that touch input may be used for secure transactions.

In some embodiments, the POS devices 30 and 32 include one or more input devices 408 for receiving input from the cardholder 22. The input devices 408 may include, for example, a keyboard, a keypad, a pointing device, a mouse, a stylus, a touch sensitive panel, a touch pad, a touch screen, a gyroscope, an accelerometer, a position detector, or an audio input device. A single component such as a touch screen may function as both an output device of the media output component 406 and the input device 408. In addition, the input devices 408 may include payment card readers, including, for example, a contact card reader, a wireless card reader, and/or a magnetic stripe reader. The wireless card reader may include, for example, Bluetooth communication, radio frequency communication, near field communication (NFC), network-based communication, and the like configured to communicate with the cardholder's payment device. Moreover, in some embodiments, the input devices 408 may include a biometric input device for the cardholder 22 to enter a biometric sample. For example, the POS devices 30 and 32 may include an integral fingerprint or palm reader/scanner, retinal or iris reader/scanner, and/or voice reader/recorder.

The POS devices 30 and 32 may also include a communication interface 410, which is communicatively couplable to a remote device such as the server system 26 and/or the network 36. The communication interface 410 may include, for example, a wired or wireless network adapter (e.g., Wi-Fi, IEEE 802 including Ethernet, WiMAX, and/or others), including supporting various local area networks (LANs), personal area networks, or short-range communications protocols. Moreover, in some embodiments, the communication interface 410 may include a wireless data transceiver for use with a mobile phone network, Global System for Mobile communications (GSM), CDMA, TDMA, WCDMA, LTE, EDGE, 3G, 4G or other mobile data network.

Stored in the memory component 404 are, for example, computer readable instructions for providing a user interface to the cardholder 22 via the media output component 406 and, optionally, receiving and processing input from the input device 408. A user interface may include, among other possibilities, a web browser and a client application. Web browsers enable users, such as cardholder 22, to display and interact with media and other information typically embedded on a web page or a website from server system 36. A client application allows the cardholder 22 to interact with a server application from the server system 26.

The memory component 404 may include, for example, and without limitation, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

In some embodiments, the POS devices 30 and 32 may be connected to one or more peripheral devices (not shown). That is, the POS devices 30 and 32 may communicate various data with one or more peripheral devices. For example, the POS devices 30 and 32 may communicate with one or more peripheral devices through the communication interface 410 via Wi-Fi, Bluetooth, NFC, and/or any other suitable communication means. When the POS devices 30 and 32 and a peripheral device communicate with each other through one of the wireless communication methods, a connection procedure necessary for a corresponding communication method may be performed. For example, and without limitation, when the POS devices 30 and 32 and a peripheral device attempt to communicate with each other through Bluetooth communications, a pairing procedure necessary for a Bluetooth communication method may be initiated by the POS devices 30 and 32. Example peripheral devices include, but are not limited to, optical barcode readers, receipt printers, card payment signature pads, payment card chip readers, cash drawers, keyboards, mice, and the like.

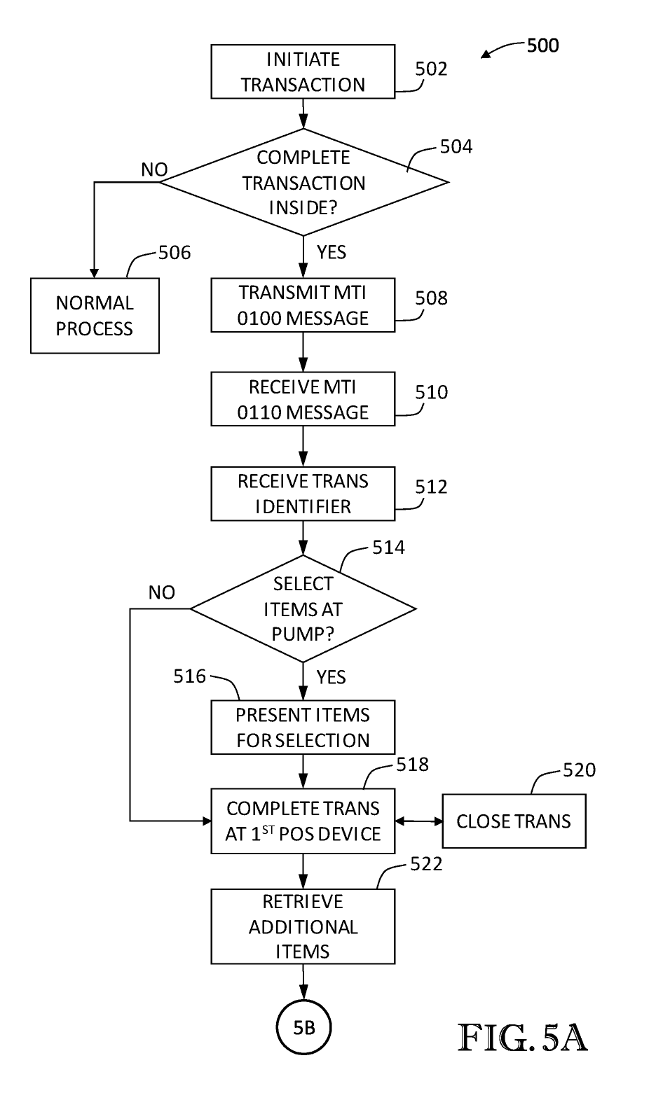

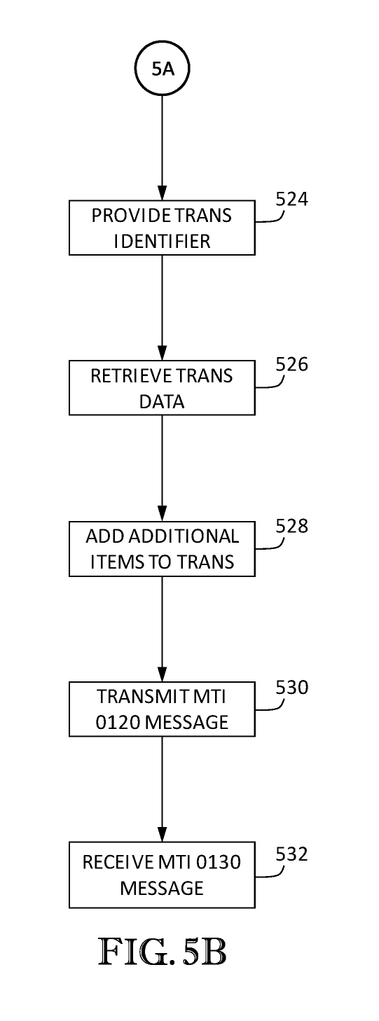

FIGS. 5A and 5B shows a flow chart of an example method 500 for processing a payment transaction at a merchant store in accordance with one embodiment of the present disclosure. The method 500 may be performed by a payment system, and more particularly, by the multi-party payment card network system 10 as described with reference to FIGS. 1-4. The method 500 is a computer-implemented method for performing a transaction utilizing at least two POS devices, for example, by initiating the transaction and requesting a payment authorization request on the first POS device 30, transferring the transaction to the second POS device 32, and completing the transaction on the second POS device 32 by transmitting an authorization advice message to the issuer 18. In the example embodiment, the method 500 is described with reference to the merchant 12 being an automotive fuel filling station. However, it is noted that the method 500 can be performed by any merchant type and in any merchant location that utilizes at least two POS devices, and wherein it is desirable to leave a transaction “open” as a customer moves from one POS device to another.

With reference to FIGS. 1-4, 5A, and 5B, in the exemplary embodiment, at operation 502, the cardholder 22 may initiate a transaction at a first POS device 30 of the point-of-sale system 38, for example, and without limitation, located at an automated fuel pump (not shown). For example, the cardholder 22 may swipe or use a transaction card such as a rewards card, a credit card, a debit card, or the like, at the first POS device 30, e.g., at the initiation of a transaction. In some embodiments, the cardholder 22 may use a digital wallet (not shown) to wirelessly transmit digital wallet data to the first POS device 30, for example, by NFC, Bluetooth, or other wireless communications via the communications interface 410 or a peripheral device coupled to the first POS device 30. One or more attributes, including a cardholder name and primary account number (PAN), may obtained from the transaction card or digital wallet data, and may be used to identify the cardholder 22 and initiate the transaction, storing the transaction data in the memory component 404.

At operation 504, the first POS device 30 may present to the cardholder an option to complete the transaction at the second POS device 32, which is located inside the store of the merchant 12. As an example, it may be desirable to leave the transaction “open” to facilitate additional purchases of items located inside the store. If the cardholder 22 chooses to complete the transaction at the first POS device 30, i.e., not to complete the transaction inside the store, the transaction proceeds normally at operation 506 and is processed as a typical transaction at the POS device. If the cardholder 22 chooses to complete the transaction inside the store, the transaction proceeds to operation 508 described below.

At operation 508, the first POS device 30 preferably transmits a payment authorization request message (e.g., a message type indicator (MTI) “0100” message) for authorization for a cardholder purchase and transmits it to the issuer 18 via the network 20. The MTI “0100” message may be formatted as a preauthorization request. The preauthorization request may include a primary account number relating to the cardholder's payment account and a request to place a funds hold amount against the account. The funds hold amount may include, for example: a nominal amount of funds (e.g., $1.00); an estimated amount of funds based on an algorithm, historical spending data analyses, or the like; a maximum predetermined amount of funds (e.g., a chargeback (CB) amount of $75.00); or an amount of funds greater than the CB amount, as determined by the merchant 12 and/or the acquirer 14. In some embodiments, the funds hold amount may be omitted and the preauthorization request may merely request that a transaction be opened against the account. The funds amount may be indicated in data element 4 (DE4) of the MTI “0100” message. In one embodiment, the amount of funds in DE4 of the MTI “0100” message may be adjusted based on the cardholder's selection at operation 504. For example, if the cardholder selects to complete the transaction inside the store, the DE4 amount may be increased as compared to a DE4 amount transmitted during a normal transaction, such as at operation 506.

As shown at operation 510, the issuer 18 may transmit an authorization request response message (MTI “0110” message) to the merchant 12 for the preauthorization amount. In some embodiments, in the case of a request having a DE4 nominal mount or an amount greater than the CB amount, the MTI “0110” message may authorize the CB amount, i.e., a $75.00 hold for purposes of protecting the merchant 12 and not the nominal $1.00 amount or the amount greater than the CB amount. In some embodiments, where the cardholder's account does not have the funds and/or credit available for the CB amount or the preauthorization request amount, the issuer 18 may authorize a lesser amount if the acquirer 14 and/or merchant 12 supports partial approvals. The preauthorized amount (e.g., the CB amount) is held against the open to buy amount associated with the cardholder's account. Upon receipt of the MTI “0110” message, the merchant 12 may set the automated fuel pump to the preauthorized amount and/or the preauthorized CB amount.

At operation 512, the first POS device may present a transaction identifier to the cardholder 22, via, for example, the media output component 406. The transaction identifier may be in the form of a machine-readable (optical) code (e.g., a bar code, QR code, etc.), a unique identification number to be entered into another POS device, such as the second POS device 32 of the point-of-sale system 38, or any other form suitable for use in the systems and methods as disclosed herein. The first POS device stores a copy of the transaction identifier with the transaction data in the memory component 404, where it may be used, for example, by the second POS device 32, to identify and retrieve the associated transaction data. In some embodiments, the transaction identifier may be presented to the cardholder 22 via a receipt printed by the first POS device 30. In other embodiments, the transaction identifier may be scanned by a consumer computing device, such as a Smartphone, and stored therein.

In some embodiments, the transaction identifier may be generated as a biometric identifier. For example, the cardholder 22 may provide a biometric sample to be associated with the transaction data. Biometric samples include, without limitation, a fingerprint image, a voice recording, a retinal image, facial recognition, palm print image, iris recognition, and the like. The biometric sample is unique to the cardholder 22 and difficult to duplicate and/or forge by an unauthorized user. The biometric sample is stored and associated with the biometric identifier. Additionally, the biometric identifier is associated with the stored transaction data and facilitates secure authorization of the transaction initiated by the cardholder 22. A biometric input device in communication with the POS devices 30 and 32 may be used for the cardholder 22 to enter the biometric sample. For example, the POS devices 30 and 32 may include an integral fingerprint or palm reader/scanner, retinal or iris reader/scanner, and/or voice reader/recorder.

In another embodiment, the transaction identifier may be associated with a digital wallet ID transmitted to the POS device as part of a wireless digital wallet transaction. To complete the transaction at the second POS device 32, the cardholder may provide a biometric sample to a cardholder computing device containing the digital wallet data to facilitate transmitting the digital wallet ID to the second POS device 32. The second POS device 32 may use the digital wallet ID to retrieve the associated with the transaction data.

At operation 514, the first POS device 30 may present to the cardholder 22 an option to select at the automated fuel pump additional items for purchase. If the cardholder chooses not to make additional selections at the automated fuel pump, the method 500 continues at operation 518. If the cardholder 22 chooses to make additional selections at the automated fuel pump, the method 500 proceeds to operation 516 described below.

At operation 516, the first POS device 30 presents the additional items to the cardholder 22. For example, the media output component 406 may be used to present the items to the cardholder 22, where the cardholder may select the items using, for example, a touch sensitive display. This may facilitate reducing waiting time for the cardholder 22, for example, when one or more additional items needs additional processing time, such as heated food items. In addition, the merchant 12 may provide a collection service for collecting the additional items for the cardholder 22 for pickup within the store. By selecting the additional items outside at the automated fuel pump, the cardholder 22 may reduce wait time for the collection of the selected items.

At operation 518, the cardholder completes at least a portion of the transaction at the first POS device 30, for example, by completing fueling of an automobile. When the portion of the transaction at the first POS device 30 is complete, the first POS device 30 may store the transaction amount with the transaction data in the memory component 404. In addition, at operation 520, the first POS device 30 may suspend the transaction at the POS device 30, e.g., by appending a SUSPEND indicator to the transaction data in the memory component 404, thereby preventing additional purchases against the transaction at the first POS device 30.

At operation 522, the cardholder may enter the store to select additional items for purchase and/or to retrieve any additional items selected for purchase at the automated fuel pump. For example, the cardholder 22 may pick up any ordered food items, or retrieve the items from the merchant's collection service. In addition, the cardholder 22 may select additional items from within the store and take them to a checkout location for purchase.

At operation 524, the cardholder provides the transaction identifier to the second POS device 32 of the point-of-sale system 38, for example, by entering the unique identification number or scanning the optical code (e.g., the bar code, QR code, etc.) using an input device 408. In some embodiments, the cardholder may provide a biometric sample at the second POS device 32. At operation 526, the second POS device 32 may use the transaction identifier to retrieve the transaction data from the first POS device 30. Because the first and second POS devices 30 and 32 are in direct communication with each other via the network 36, the POS devices 30 and 32 may be able to scan the memory components of each POS device to locate the identified transaction. After locating the transaction data, the second POS device 32 may check that the transaction was suspended at the first POS device 30, for example, by identifying the SUSPEND indicator. If the transaction data does not include a SUSPEND indicator, the second POS device 32 may request the first POS device 30 to suspend the transaction prior to the second POS device 32 retrieving the transaction data. After retrieving the transaction data, the second POS device 32 may add the cardholder's additional items to the transaction at operation 528.

When the transaction is completed, at operation 530, the merchant 12 may transmit to the issuer 18 an MTI “0120” authorization advice message containing a final transaction amount. Upon receipt of the MTI “0120” message, at operation 532, the issuer 18 may acknowledge the transaction and transmit an MTI “0130” authorization advice response message to the merchant 12. The issuer 18 may then release the hold against the cardholder's account that is more than the pre-authorized amount, for example, by changing the CB amount held against the cardholder's open to buy balance to the final transaction amount.

Any actions, functions, operations, and the like recited herein may be performed in the order shown in the figures and/or described above, or may be performed in a different order. Furthermore, some operations may be performed concurrently as opposed to sequentially. Although the computer-implemented method is described above, for the purpose of illustration, as being executed by an example system and/or example physical elements, it will be understood that the performance of any one or more of such actions may be differently distributed without departing from the spirit of the present disclosure.

A computer-readable storage media or medium comprising a non-transitory medium may include an executable computer program stored thereon and for instructing one or more processing elements to perform some or all the operations described herein, including some or all the operations of the computer-implemented method. The computer program stored on the computer-readable medium may instruct the processor and/or other components of the system to perform additional, fewer, or alternative operations, including those discussed elsewhere herein.

All terms used herein are to be broadly interpreted unless otherwise stated. For example, the term “transaction card” and the like may, unless otherwise stated, broadly refer to substantially any suitable payment card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transaction card can be used as a method of payment for performing a transaction.

The terms “processor,” “processing element,” and the like, as used herein, may, unless otherwise stated, broadly refer to any programmable system including systems using central processing units, microprocessors, microcontrollers, reduced instruction set circuits (RISC), application specific integrated circuits (ASIC), logic circuits, and any other circuit or processor capable of executing the functions described herein. The above examples are example only, and are thus not intended to limit in any way the definition and/or meaning of the term “processor.” In particular, a “processor” may include one or more processors individually or collectively performing the described operations. In addition, the terms “software,” “computer program,” and the like, may, unless otherwise stated, broadly refer to any executable code stored in memory for execution on mobile devices, clusters, personal computers, workstations, clients, servers, and a processor or wherein the memory includes read-only memory (ROM), electronic programmable read-only memory (EPROM), random access memory (RAM), erasable electronic programmable read-only memory (EEPROM), and non-volatile RAM (NVRAM) memory. The above memory types are example only, and are thus not limiting as to the types of memory usable for storage of a computer program.

The terms “computer,” “computing device,” “computer system,” and the like, as used herein, may, unless otherwise stated, broadly refer to substantially any suitable technology for processing information, including executing software, and may not be limited to integrated circuits referred to in the art as a computer, but may broadly refer to a microcontroller, a microcomputer, a programmable logic controller (PLC), an application specific integrated circuit, and other programmable circuits, and these terms are used interchangeably herein.

The term “network,” “communications network,” and the like, as used herein, may, unless otherwise stated, broadly refer to substantially any suitable technology for facilitating communications (e.g., GSM, CDMA, TDMA, WCDMA, LTE, EDGE, OFDM, GPRS, EV-DO, UWB, Wi-Fi, IEEE 802 including Ethernet, WiMAX, and/or others), including supporting various local area networks (LANs), personal area networks (PAN), or short-range communications protocols.

The term “communication component,” “communication interface,” and the like, as used herein, may, unless otherwise stated, broadly refer to substantially any suitable technology for facilitating communications, and may include one or more transceivers (e.g., WWAN, WLAN, and/or WPAN transceivers) functioning in accordance with IEEE standards, 3GPP standards, or other standards, and configured to receive and transmit signals via a communications network.

The term “memory component,” “storage device,” and the like, as used herein, may, unless otherwise stated, broadly refer to substantially any suitable technology for storing information, and may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

Although the disclosure has been described with reference to the one or more embodiments illustrated in the figures, it is understood that equivalents may be employed and substitutions made herein without departing from the scope of the disclosure as recited in the claims.

Having thus described one or more embodiments of the disclosure, what is claimed as new and desired to be protected by Letters Patent includes the following:

1. A point-of-sale system for processing a payment transaction at a merchant store, said point-of-sale system comprising:
a first point-of-sale device comprising:
a memory device for storing data; and
a first processor communicatively coupled to said memory device, said first processor programmed to:
receive transaction card information for the payment transaction, the transaction card information including a primary account number relating to a payment account of a cardholder;
transmit a payment authorization request message including the primary account number;
present to the cardholder a transaction identifier for the payment transaction; and
store transaction data associated with the payment transaction in said memory device; and
a second point-of-sale device comprising a second processor programmed to:
receive the transaction identifier for the payment transaction;
retrieve the transaction data associated with the transaction identifier from said memory device; and
transmit an authorization advice message including the primary account number relating to the payment account.

2. The point-of-sale system in accordance with claim 1,
said first processor programmed to present to the cardholder an option to select to complete the transaction at the first point-of-sale device or at the second point-of-sale device.

3. The point-of-sale system in accordance with claim 1,
said first processor programmed to transmit the payment authorization request message to an issuer, the payment authorization request message including a preauthorization requesting placement of a funds hold amount against the payment account.

4. The point-of-sale system in accordance with claim 3,
said first processor programmed to adjust the funds hold amount based on the cardholder selection.

5. The point-of-sale system in accordance with claim 3,
said first processor programmed to receive an authorization request response message for the funds hold amount, the funds hold amount held against an open to buy amount of the payment account.

6. The point-of-sale system in accordance with claim 3,
wherein the finds hold amount includes one of the following: a nominal amount, an estimated amount, and a maximum predetermined amount.

7. The point-of-sale system in accordance with claim 1,
the transaction identifier for the payment transaction including one or more of the following: a machine-readable code, a unique identification number, and a biometric identifier.

8. The point-of-sale system in accordance with claim 1,
said first processor programmed to present to the cardholder an option to select at the first point-of-sale device additional items for purchase.

9. The point-of-sale system in accordance with claim 8,
said first processor programmed to, in response to the cardholder selection, present to the cardholder via a media output component the additional items for purchase.

10. The point-of-sale system in accordance with claim 1,
wherein receiving the transaction identifier comprises receiving from the cardholder one or more of the following: a machine-readable code, a unique identification number, and a biometric identifier.

11. The point-of-sale system in accordance with claim 1,
said first processor programmed to suspend the payment transaction at the first point-of-sale device.

12. The point-of-sale system in accordance with claim 11,
wherein suspending the payment transaction at the first point-of-sale device comprises appending a SUSPEND indicator to the transaction data stored in said memory device, thereby preventing additional purchases against the transaction at the first point-of-sale device.

13. The point-of-sale system in accordance with claim 11,
said second processor programmed to check whether the payment transaction was suspended at the first point-of-sale device by identifying a SUSPEND indicator appended to the transaction data.

14. The point-of-sale system in accordance with claim 13,
wherein if the transaction data does not include the SUSPEND indicator, said second processor programmed to request the first point-of-sale device to suspend the transaction.

15. The point-of-sale system in accordance with claim 1,
said second processor programmed to add additional items to be purchased to the payment transaction.

16. The point-of-sale system in accordance with claim 1,
said second processor programmed to transmit the authorization advice message to an issuer.

17. The point-of-sale system in accordance with claim 16,
the authorization advice message including a final transaction amount.

18. The point-of-sale system in accordance with claim 1,
said second processor programmed to receive an authorization advice response message in response to the authorization advice message.

19. The point-of-sale system in accordance with claim 1,
wherein receiving the transaction card information for the payment transaction comprises reading from a transaction card one or more of the following: a magnetic stripe, a chip, and embossed characters.

20. The point-of-sale system in accordance with claim 1,
wherein receiving the transaction card information for the payment transaction comprises receiving digital wallet data wirelessly, the digital wallet data including the transaction card information.
